(19) United States
(12) Patent Application Publication
(10) Pub. No.: US 2005/0226007 A1
(43) Pub. Date: Oct. 13, 2005

(54) Push-on bulb base

(76) Inventor: Chuan Ying Chen, Hsinchu City (TW)

Correspondence Address: LEONG C LEI, PMB # 1008, 1867 YGNACIO VALLEY ROAD, WALNUT CREEK, CA, 94598, US

(21) Appl. No.: 10/820,716

(22) Filed: Apr. 9, 2004

(51) Int. Cl. F21V 19/02

(52) U.S. Cl. 362/655; 362/652; 362/656

(57) ABSTRACT

The present invention concerns a push-on bulb base, which is installed on the one end of the power cord to provide the installation of light bulbs with spiral denting lines encircling the surface of the bulb cap. It comprises an insulation cover installed with a containing trough for the bulb cap, and the containing trough constructing of a first electric conduct piece, a second electric conduct piece, a clipping foot piece of axial shifting, a push-on fitting mechanism enabling the said clipping foot piece to be fitted on the upper and lower section to and fro; wherein, the preceding clipping foot piece has several flexible foot posts which can moving close to the containing trough wall, and a bulger is installed on each of the rear rims.

### BACKGROUND OF THE INVENTION

(a) Technical Field of the Invention

The present invention concerns a push-on bulb base, especially a type specially provided for the installing of light bulbs with denting spiral lines encircling the surface of the bulb cap, and in turn achieving a bulb base structure design that has a easier and handier practice effect in the changing and installing of light bulbs.

(b) Description of the Prior Art

Accordingly, prior art illuminating light bulbs usually seen in the general market, such as tungsten light bulbs and electricity-saving light bulbs, mainly have metal bulb caps with spiral denting lines encircling the surface covering the output terminal of the foot of the light bulb, this is to achieve the function of fixing the light bulb onto the bulb base using the matching combination of the spiral denting lines. Prior art bulb base structures mainly have a electric conductional spiral line base connected to the power cord installed inside the insulation cover, which in turn provide the spiraling assembling and removing application of the said light bulb. However, experience gained from long term usage has found the above mentioned prior art spiral denting line matching bulb base to have the following defects:

The process of changing the light bulbs is both energy and time consuming, whether it be installing or removing the light bulbs from the bulb bases, it is always necessary to twist the light bulb three to four times by repeating the process of grabbing then releasing the light bulb.

When intending to remove the light bulb from the bulb base, due to the fact that the user has no idea when the bulb cap will come off the bulb base, and the hand requires the repetition of releasing the light bulb and then changing the supporting angle to twist the light bulb, it causes great pressure of fearing that the light bulb will come off the bulb base right when the hand leaves the light bulb. This phenomenon is even more obvious when changing electricity-saving light bulbs that are bigger and heavier, and resulted in the fact that females in general are afraid to undertake the simple process of changing light bulbs.

When the light bulb on the bulb base is broken by outer force, it often causes the remaining of only the bulb cap on the bulb base, and results in the user having to use pliers to grip the edge of the bulb cap and twist it to remove from the bulb base, which is very inconvenient.

In light of the above mentioned existing problems of prior art spiral denting line matching bulb base, how to provide a press and push bulb base structure design using the press and push operating method that is much simpler and handier to accomplish the process of changing light bulbs, becomes the invention motive and design key of the present invention.

### SUMMARY OF THE INVENTION

The main object of the present invention is to provide a push-on bulb base installed on the one end of the electric cord for the installing of light bulbs with spiral denting lines encircling the surface of the bulb cap, and in turn achieving a simpler and handier practice effect of the process of changing light bulbs.

In order to achieve the above mentioned goal, the present invention push-on bulb base comprises of an insulation cover with bulb cap containing trough, and a first electric conduction piece, second electric conduction piece, a clipping foot piece of axial shifting, a push-on fitting mechanism enabling the said clipping foot piece to be fitted on the upper or the lower section to and fro.

The characteristics are as the following: the above mentioned clipping foot piece is constructed of a breaking tube of axial shifting, and several long foot posts connected to the rear end of the breaking tube which can move close along the side of the containing trough, wherein the said foot posts possess flexibility with a bulger installed on the inter surface of the rear end, and the closing surface of the container trough of the cover has lower cases. With which, on the strength of the push-on operation of the light bulb cap end on the clipping foot piece, when the clipping foot piece is fitted on the lower section, the bulger on the rear end of the foot post can squeeze and lean against the lower cases on the inter surface, and that which is embedded against the inside of the spiral denting lines will hold fix the bulb cap within the bulb base. When the clipping foot piece is fitted on the upper section, it will enable the bulger on the rear end of the foot post levitate the bulb cap with spiral denting lines which have regained the original place, and in turn enabling the bulb cap to be released smoothly from the container trough and the light bulb removed. This will achieve the practice effect of push-on installation and removal of light bulbs.

Following the aforementioned push-on bulb base, wherein the first electric conduction piece and the second electric conduction piece are flexible pieces, which are fixed on the two sides of the clip and release foot piece with the top providing the connection of power cords. The rear end of the said first electric conduction piece is bended and extended to the moderate part of the clip and release foot piece, and the rear end of the second electric conduction piece is bended so that it can touch the outer surface of the bulb cap. By means, when the bulb cap is clipped inside the containing trough by the clipping foot pieces, it also achieves the state of electric conducted.

Following the aforementioned press and push bulb base, wherein the foot post of the said clipping foot piece includes long and short equipped forms, and will provide the application of the push-on installation and removal of light bulbs with spiral denting lines encircling the surface of the bulb cap.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention;

FIG. 2 is an exploded view of the present invention;

FIG. 3 is an assembly construction sectional view of the present invention;

FIG. 4 is a circuit power conduct sketch map of the present invention;

FIG. 5 is the construction sketch map of another preferred embodiment of the present invention;

FIG. 6 is the construction sketch map of another preferred embodiment of the present invention;

FIG. 7 is the construction sketch map of another preferred embodiment of the present invention under application on general spiral denting line matching light bulbs;

FIG. 8 is the construction sketch map of another preferred embodiment of the present invention under application on general spiral denting line matching light bulbs.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

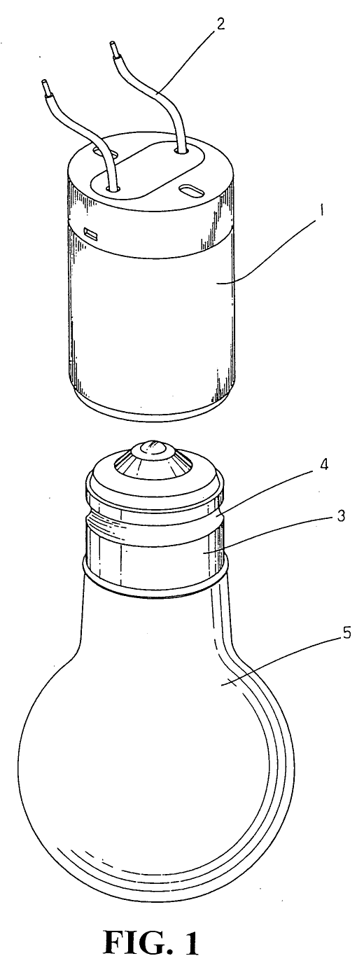

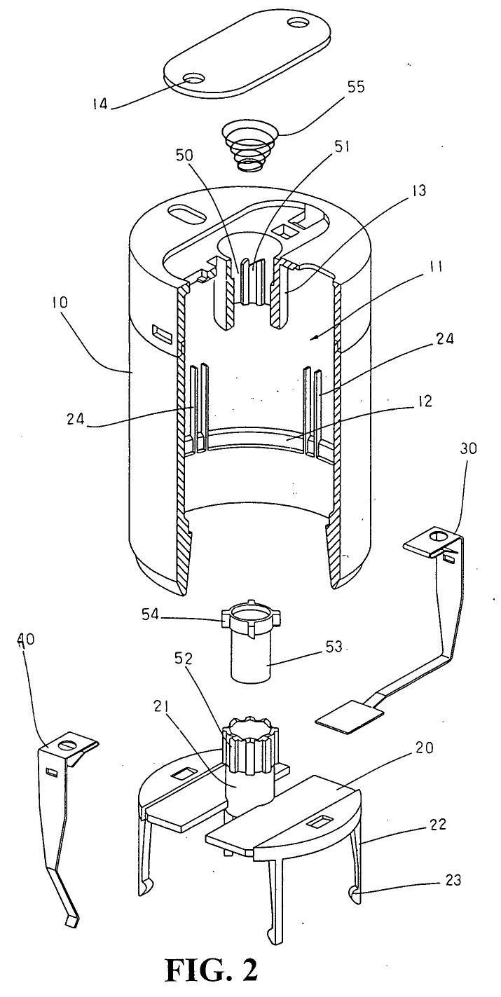

The present invention is a push-on bulb base, as referred to in FIG. 1, the perspective view of the present invention. Wherein the body (1) is installed on the one end of the power cord (2) to provide the installation of light bulbs (5) with spiral denting lines (4) encircling the surface of the bulb cap (3). With further reference to FIG. 2, the exploded view of the present invention, comprising an insulation cover (10), a first electric conduction piece (30), a second electric conduction piece (40), a clipping foot piece (20), and a push-on fitting mechanism, wherein:

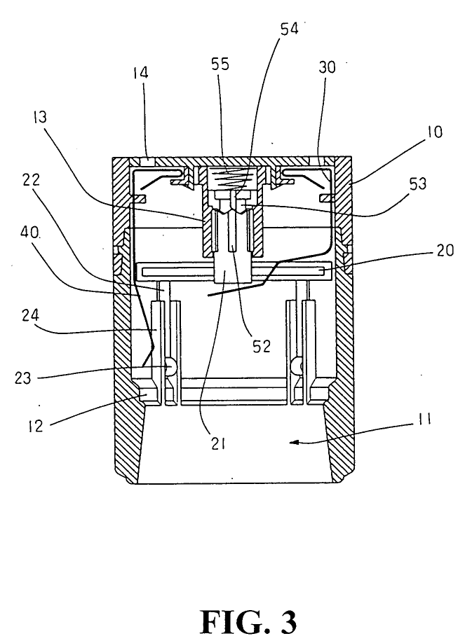

The said insulation cover (10), with further reference to FIG. 2 and FIG. 3, is a cover installed with the containing trough (11) providing the action light bulb cap. There are lower cases on the wall of the opening on the said containing trough when it closes inwardly, and opposite to the wall of the opening has a sliding cover (13) to restrict the axial shifting of the clipping foot piece (20) installed, and on the wall of the two sides of the sliding cover has a set of openings (14) for the power cords.

Furthermore, the said clipping foot piece (20) is constructed of a breaking tube (21) which can move up and down inside the sliding cover, and several long foot posts (22) connected to the rear end of the breaking tube which can move close along the side of the containing trough, wherein the said foot posts possess flexibility with a bulger (23) installed on the inter surface of the rear end. When the clipping foot piece (20) is fitted and on the upper section, the rear rim of the said foot posts (22) are higher the rim of the lower cases (12) of the wall of the containing trough. Also, the distance between created by the bulger (23) on the rear rim of the foot posts is slightly bigger than the biggest extra diameter of the bulb cap (3), this is so that the bulb cap can move in and out of the top of the containing trough to push the clipping foot piece. When the clipping foot piece (20) is fitted on the lower section, the bulger (23) of the foot posts can squeeze and lean against the lower cases (12) on the inter surface to create a buckling effect.

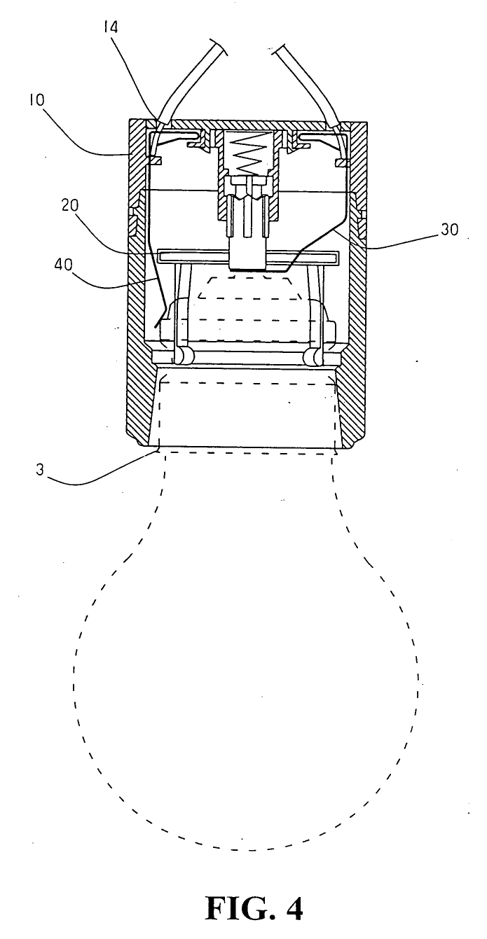

Moreover, the said first and second electric conduct piece (30. 40) as referred to in FIG. 2 and FIG. 4 are pieces with flexibility. The tops of the pieces each match the power cord openings (14) on the cover and are fixed inside the containing trough, wherein the rear end of the said first electric conduct piece (30) is bent and extended towards the rear rim of the breaking tube (21) of the clipping foot piece, whereas the rear end of the said second electric conduct piece (40) is bent and extended to touch the outer rim of the bulb cap which is extended into the containing trough, making the bulb cap (3) push the clip and release foot piece (20) the same time as creating a conducted power circuit.

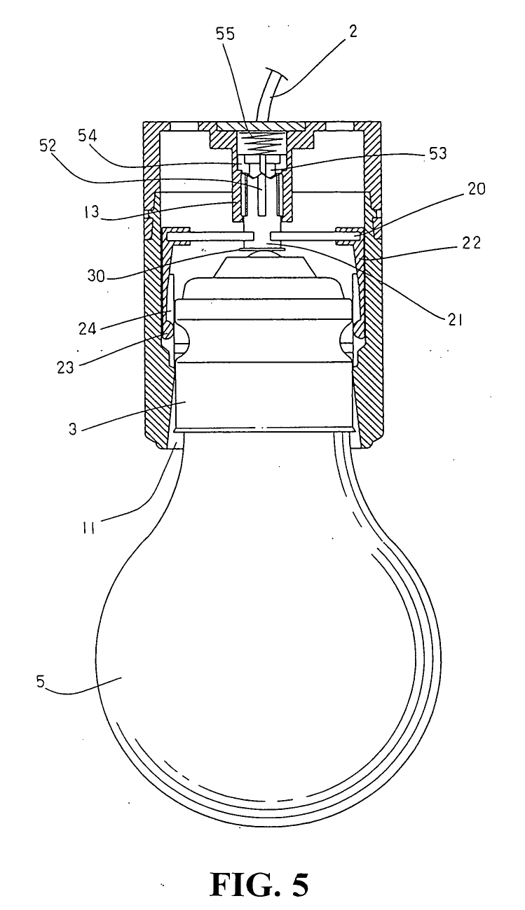

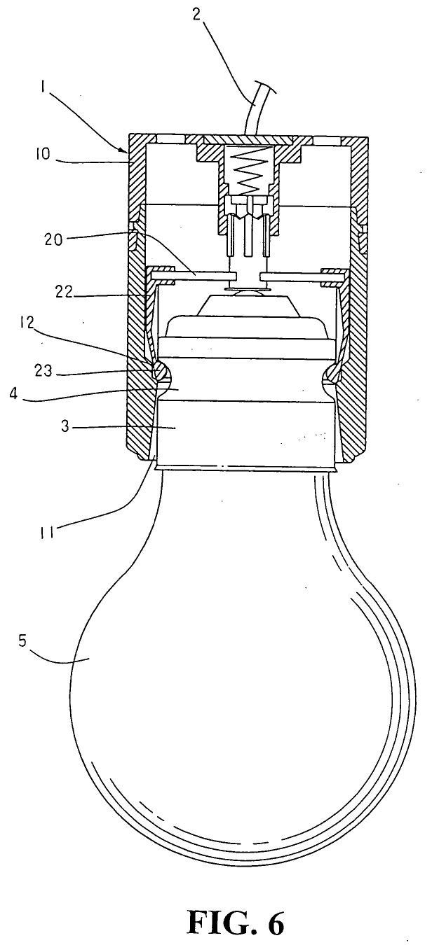

Additionally, the said push-on fitting mechanism, as referred to in FIG. 2, FIG. 5 and FIG. 6, are prior art jump-key mechanism widely applied to push-on pens. It mainly enables the clipping foot piece (20) to activate and fit between the upper and lower sections by the strength of the repeated push-on operation. As for the application revealed in these figurations, it has the inter wall face of the sliding cover (13) installed with vertical deep and shallow trough paths (50. 51) spaced at intervals, cuttings (52) are installed on the outer rim of the top of the breaking tube (21) of the clipping foot piece to restrict the up and down shifting inside the preceding trough paths, a blocking (53) is installed on top of the breaking tube (21) possessing the ability to spin and shift up and down. The top of the said blocking has several blocking teeth (54) installed on the outer surface, and a bounce-back spring (55) is installed in between the top of the blocking and the inter top surface of the sliding cover. With which, by one trip of the push-on clipping foot piece (20) rising to the top, it will make the blocking (53) compress the bounce-back spring (55), rotate and in turn making the rear rim of the blocking teeth (54) to be fitted at the top rim of the shallow trough path (51). Furthermore, with another trip of the push-on clipping foot piece (20) rising to the top, it will make the blocking (53) to again rotate and make the blocking teeth (54) fall into the deep trough path. With the restoring force of the bounce-back spring (54), the blocking (53) can repress the clipping foot piece to move down altogether.

As the above-mentioned push-on bulb base, with reference to FIG. 5 and FIG. 6, after it is being installed to one end of the power cord (2), when intending to install a light bulb, all that is required is to place the bulb cap (3) into the containing trough (11) and perform the operation of pushing the clipping foot piece (20) which is fitted on the upper section right to the bottom, and the light bulb (5) can be released. When the light bulb is being released, the clipping foot piece (20) will be repressed and fitted on the lower section along with the bulb cap (3), the rear end of the foot posts (22) will squeeze and lean inwardly, making the bulgers (23) foot posts fit between the rim of the lower cases (12) and the spiral denting lines (4) on the bulb cap, and in turn securing the light bulb (5) onto the bulb base (1). When intending to change a light bulb, all it takes is to give the light bulb installed on the bulb base a push to the bottom, and it will make the clipping foot pieces (20) clip to the upper section, and the bulgers (23) on the end of the foot posts will be moved from the lower cases (12) and resume the original state with its own flexibility, and the light bulb may be removed. This achieves the practical effect of simple and handy push-on installation and removal of light bulbs.

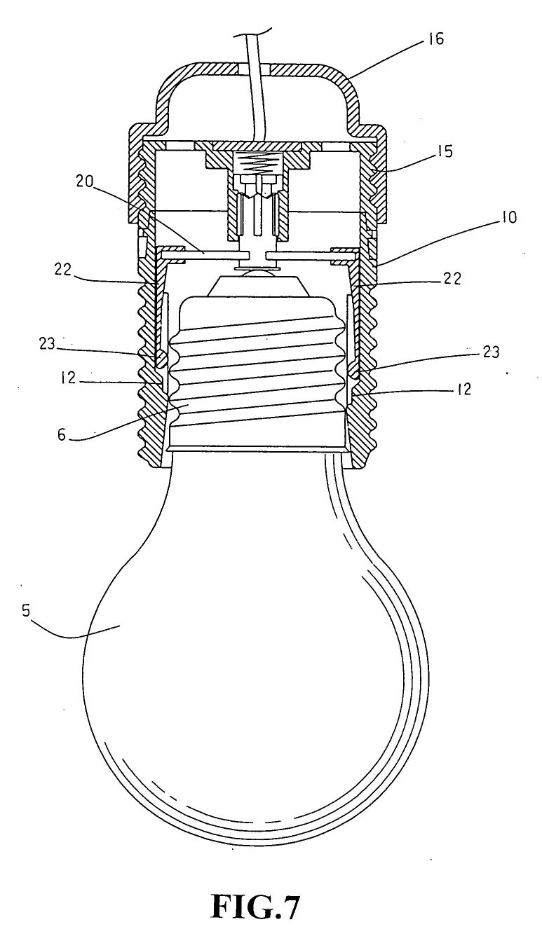

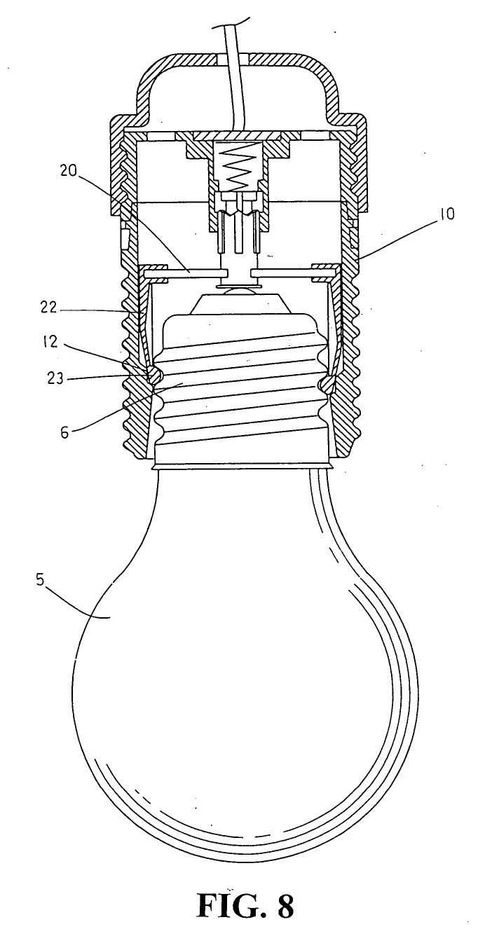

As the above-mentioned push-on bulb base, since the clipping foot piece (20) is using the bulger (23) on the rear end of the foot post to act as embedment against the spiral denting lines (4) on the bulb cap, and the rear end of the foot posts (22) create the squeezing and leaning inward effect with the lower cases (12) of the closing of the containing trough wall. Therefore, the length of the foot posts (22) and the height and form of the spiral denting lines (4) of the bulb cap should be correspondent, and the height of the lower cases (12) and the length of the foot posts (22) should also be correspondent. Consequently, as referred to in FIG. 7 and FIG. 8, the present invention can alter the corresponding height of the lower cases (12) according to the change in the length of the foot posts (22), and at the same time also apply to the push-on installation and removal of light bulbs (7) with spiral denting lines (6) encircling the surface of the bulb cap. With further description as the following: when the denting lines on the bulb cap are general spiral denting lines (6), the foot posts (22) that are connected to the rear end of the breaking tube will be adjusted to become the length with which the bulgers (23) at the rear end of the foot posts will correspond to the spiral denting lines and able to embed, and the lower cases (12) will become the height required to guide the bulgers (23) on the end of the foot posts to squeeze and lean inwardly to embed in the spiral denting lines (6), when the clipping foot pieces (20) are fitted on the lower section. This will in turn achieve the practical effect of the push-on installation and removal application for light bulbs (7) with spiral denting lines encircling the surface of the bulb cap.

As the above-mentioned push-on bulb base, as referred to in FIG. 2, FIG. 3 and FIG. 6, wherein the wall of the said containing trough has bar tracks (24) installed to restrict the up and down shifting of foot posts (22), and to provide a base support for when the clipping foot pieces (20) are fitted on the lower section. By the strength, it will achieve the stability of the up and down shifting of the clipping foot pieces (20), and the fitting securing.

As the above-mentioned push-on bulb base, as referred to in FIG. 7 and FIG. 8, the outer surface of the cover (10) in the present invention also has spiral denting lines (15) installed, so as to better convenient the combination usage of accessories such as cap cover (16) for covering the connecting end of power cords, or lamp cover.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A push-on bulb base installed on the one end of the power cord to provide the installation of light bulbs with spiral denting lines encircling the surface of the bulb cap, comprising an insulation cover installed with a containing trough for the bulb cap constructed of a first electric conduct piece, a second electric conduct piece, a clipping foot piece of axial shifting, a push-on fitting mechanism which enables the clipping piece to be clipped on the upper or lower section to and fro; whereas the feature is the preceding clipping foot piece is constructed of a breaking tube of axial shifting, and several equal length foot posts which are connected to the rear end of the breaking tube and can move close to the wall of the containing trough, wherein the said foot posts are flexible and has a bulger installed on the rear rim, and the closing of the containing trough wall in the cover has lower cases, with which, when the bulb cap end of the light bulb performs the push-on operation on the clipping foot piece, and the clipping foot piece is fitted on the lower section, the bulgers on the rear end of the foot posts will squeeze and lean inwardly along the surface of the lower cases, and embed in the spiral denting lines to secure the light bulb onto the bulb base; when the clipping foot piece is fitted on the upper section, it will levitate the bulgers and release the spiral denting lines, and the light bulb can be removed successfully; in turn achieving the practical effect of the push-on installation and removal of light bulbs.

2. The push-on bulb base as claimed in claim 1, wherein the first electric conduct piece and the second electric conduct piece are flexible pieces, and rear end of the said first electric conduct piece is bended and extended to the rear end of the breaking tube, whereas the rear end of the said second electric conduct piece is bended and extended to touch the outer surface of the bulb cap which is inserted into the containing trough.

3. The push-on bulb base as claimed in claim 1, wherein the said containing trough has bar tracks installed on the wall to restrict the up and down shifting of the foot posts, and also to provide a base support for the clipping foot piece when it is fitted on the lower section.

4. The push-on bulb base as claimed in claim 1, wherein the foot posts of the said clipping foot piece are equipped in long and short forms, and the lower cases on the inside of the containing trough wall provide the height required for the rear end of the preceding long and short foot posts to squeeze and lean inwardly at the same time.

5. The push-on bulb base as claimed in claim 1, wherein the said cover has spiral denting lines on the outer surface.
